(19) United States
(12) Patent Application Publication
(10) Pub. No.: US 2009/0053580 A1
(43) Pub. Date: Feb. 26, 2009

(54) INFLAMMABLE SUBSTANCE SENSOR AND FUEL CELL INCLUDING THE SAME

(75) Inventors: Akira Morita, Tokyo (JP); Satoshi Mogi, Yamato-shi (JP); Toru Nakakubo, Kawasaki-shi (JP); Shoji Ihara, Yokohama-shi (JP); Jun Yamamoto, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/282,756

(22) PCT Filed: Oct. 12, 2007
(86) PCT No.: PCT/JP2007/070390

§ 371 Date: Sep. 12, 2008

(30) Foreign Application Priority Data
Oct. 25, 2006 (JP) 2006-290086

(51) Int. Cl. H01M 8/04; B01J 19/00

(52) U.S. Cl. 429/34; 422/68.1; 422/83

(57) ABSTRACT

There is provided an inflammable substance sensor which can be installed in a small space and a fuel cell including the same. The inflammable substance sensor for informing the outside of detection of an inflammable substance includes an odorant releasing member for releasing an odorant due to a chemical reaction of the inflammable substance.

### TECHNICAL FIELD

The present invention relates to an inflammable substance sensor, and more particularly, to an inflammable substance sensor capable of allowing a person therearound to recognize fuel leakage by odor when the fuel leakage from a fuel tank or a fuel flow path occurs.

Further, the present invention relates to a fuel cell incorporating therein the inflammable substance sensor, thereby enabling quick and reliable information of the fuel leakage compared to a related art fuel cell.

### BACKGROUND ART

Against backdrops of environmental issues such as global warming, rise in price of a crude oil, and the like, there are actively performed research and development related to alternative energies for petroleum. Examples of the alternative energies for petroleum include energies obtained by wind power generation, geothermal power generation, photovoltaic power generation, and a fuel cell. Of those, the fuel cell can perform power generation irrespective of weather conditions and can be downsized, so various improvements are made therefor in an automobile industry and a mobile device industry. Specifically, the fuel cell employing hydrogen as a fuel has a higher output than that of other fuel cells employing methanol as a fuel. Further, the hydrogen has a merit of being harmless to human bodies.

However, the hydrogen is a colorless and odorless gas. Accordingly, when the hydrogen leaks out from the fuel cell, it is difficult to recognize the leakage thereof. Therefore, there is a demand for a system for quickly and reliably informing hydrogen leakage.

Hitherto, as a method of allowing a person therearound to recognize fuel leakage when the fuel leakage occurs, there is conceived a method in which an odorant is added to a fuel gas in advance. This method is widely used for a city gas or the like. However, in a case where this method is used for the fuel cell, when the fuel gas added with the odorant is used as it is, an adverse effect is exerted to an electrolyte membrane or a catalyst, thereby causing output reduction. For that reason, in a related art fuel cell, it is necessary to remove the odorant before the fuel reaches the electrolyte membrane or the catalyst. For example, Japanese Patent Application Laid-Open No. 2002-29701 discloses a method of removing the odorant by providing a deodorizing portion immediately before the hydrogen including the odorant reaches a power generation portion of the fuel cell. Further, Japanese Patent Application Laid-Open No. 2004-134273 discloses a method of deodorizing hydrogen in the power generation portion, and Japanese Patent Application Laid-Open No. 2004-308893 discloses a method of performing deodorization by providing an odorant removing cartridge in a fuel tank.

On the other hand, as a method of detecting the fuel leakage without adding the odorant to the fuel gas, Japanese Patent Application Laid-Open No. 2004-229357 discloses a method in which a sealed container is provided so as to surround each of connecting portions between pipings constituting fuel supply passages and other members, and when a pressure increase in the sealed container is detected, a gas into which an odorant is mixed is released to the outside.

However, of the above-mentioned related examples, in the method of detecting the inflammable substance in which the odorant is added to the fuel in advance, a facility for odorizing and deodorizing is required. Accordingly, a device is increased in size. Therefore, there is a problem in that this method cannot be used for a small fuel cell for use in mobile devices or the like. Further, there is a problem in that, in a case where the leakage occurs in a portion where the fuel flows after deodorization, the leakage cannot be informed. The method of using the sealed container as disclosed in Japanese Patent Application Laid-Open No. 2004-229357 has a problem in that the method cannot be used for the power generation portion or the like of the fuel cell which requires to take in the outside air.

The present invention has been made in view of the above-mentioned problems. It is an object of the present invention to provide an inflammable substance sensor which enables to make a selection from wide range of installation positions including a position in a fuel cell where it is necessary to take in air, further enabling space saving. Specifically, it is an object of the present invention to provide an inflammable substance sensor allowing an odorant to be released by reaction with an inflammable substance, thereby detecting and informing leakage of the inflammable substance from a fuel tank or a fuel flow path owing to odor of the odorant.

### DISCLOSURE OF THE INVENTION

The present invention is directed to an inflammable substance sensor for quickly and reliably informing fuel leakage compared to a related art substance sensor by releasing an odorant when the fuel leakage occurs, and to a fuel cell incorporating therein the same.

The present invention provides an inflammable substance sensor structured as described below.

According to the present invention, there is provided an inflammable substance sensor for informing the outside of detection of an inflammable substance, including an odorant releasing member for releasing an odorant due to a chemical reaction of the inflammable substance.

Further, the present invention provides a fuel cell structured as described below.

According to the present invention, there is provided a fuel cell including:

a fuel electrode to which a fuel is supplied;

an oxidizer electrode to which an oxidizer is supplied;

a fuel cell unit having an ion conductor provided between the fuel electrode and the oxidizer electrode;

a fuel flow path;

an oxidizer flow path; and

the inflammable substance sensor including the odorant releasing member for releasing the odorant due to a chemical reaction of the inflammable substance.

According to the present invention, an inflammable substance sensor which can be installed in a small space can be provided. Further, it has a simple structure requiring no power source, so the present invention can provide an inflammable substance sensor with which a selection can be made from wide variety of installation positions and installation modes.

By mounting the inflammable substance sensor according to the present invention to the fuel cell, there can be provided the fuel cell capable of quickly and reliably informing the outside of the leakage, when fuel leakage from the fuel tank or the fuel flow path occurs, compared to a related art fuel cell.

Further features of the present invention will become apparent from the following description of exemplary embodiments with reference to the attached drawings.

### BRIEF DESCRIPTION OF THE DRAWINGS

FIG. 1 is a schematic diagram illustrating a structural example of an inflammable substance sensor according to an embodiment of the present invention.

FIG. 2 is a schematic diagram illustrating a structural example of an inflammable substance sensor having an acting portion as a structural example of an inflammable substance sensor according to an embodiment of the present invention.

FIG. 3 is a schematic diagram illustrating a structural example of a microcapsule according to an embodiment of the present invention.

FIG. 4 is a schematic diagram illustrating an example of a fuel cell according to the present invention.

FIG. 5 is a structural diagram illustrating an example of a fuel cell system according to the present invention.

FIG. 6 is a schematic diagram illustrating a catalyst layer of a fuel cell including the inflammable substance sensor according to an embodiment of the present invention.

FIG. 7 is a schematic diagram illustrating a diffusion layer of the fuel cell.

FIG. 8 is a schematic diagram illustrating a diffusion layer of a fuel cell including the inflammable substance sensor according to an embodiment of the present invention.

FIG. 9 is a schematic diagram illustrating a catalyst layer of a fuel cell including an inflammable substance sensor according to an embodiment of the present invention.

### BEST MODES FOR CARRYING OUT THE INVENTION

An inflammable substance sensor according to the present invention is an inflammable substance sensor having an odorant releasing member for releasing an odorant due to a chemical reaction of an inflammable substance when the inflammable substance comes into contact with the inflammable substance sensor.

A description will be made of an embodiment of the present invention.

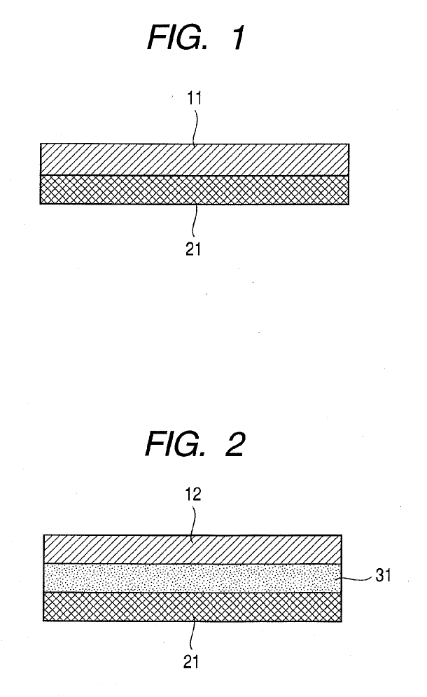

FIG. 1 illustrates a schematic diagram of a structure of an inflammable substance sensor according to this embodiment.

As illustrated in FIG. 1, at least a part of a surface of the inflammable substance sensor according to the present invention has, as the odorant releasing member, a reaction portion 11 causing a chemical reaction when the inflammable substance comes into contact therewith. The reaction portion 11 may be made of only a material for producing an odorant by reaction when the reaction portion 11 is brought into contact with the inflammable substance. Alternatively, the reaction portion 11 may be made of a mixture of the material and a binder holding the material. A support base member 21 is a base member for keeping a shape of the reaction portion 11 and is provided as needed.

Further, as illustrated in FIG. 2, an odorant releasing unit may have a structure including a reaction portion 12 which allows a chemical reaction to occur when the inflammable substance comes into contact therewith, and an acting portion 31 provided in the vicinity of the reaction portion 12, for releasing the odorant due to an action with heat or a product generated by the reaction. At least a part of the acting portion 31 is made of a material which does not generate odor before occurrence of the action but generates the odorant due to the action with the heat or the product generated by the chemical reaction caused in the reaction portion 11. The support base member is denoted by reference numeral 21.

Examples of the action in this case include vaporization, fusion, chemical reaction, dissolution, decomposition, bond, polymerization, and a physical action.

Examples of the inflammable substance used in the present invention include a hydrogen gas, a hydrocarbon gas such as a natural gas, and a hydrocarbon liquid such as methanol, ethanol, and ether.

Desirable examples of a material, which can be used for the reaction portion 11 and generates the odorant by directly chemically reacting with the inflammable substance, include sulfur, iron sulfide, a sulfur compound, iodine, iron chloride, a halogen compound, diacyl peroxides, dialkyl peroxides, peroxyketals, alkylperesters, ketones, and disulfides. Other than those, nitrogen in air may be used by being included in or allowed to flow through the reaction portion 11 as a material for generating the odorant by reacting with the inflammable substance.

Examples of the odorant used in this case include ammonia, hydrogen sulfide, hydrogen bromide, hydrogen iodide, hydrogen chloride, methanol, ethanol, propanol, phenol, alcohols, formic acid, acetic acid, propionic acid, benzonic acid, carboxylic acids, formaldehyde, acetaldehyde, benzaldehyde, aldehydes, methyl mercaptan, ethyl mercaptan, thiophenol, and thiols.

Desirable examples of a material, which can be used for the reaction portion 12 and generates heat by reacting with the inflammable substance, include metallic oxide, naphthalene, an aromatic compound, transition metal, a transition metal alloy, rare earth metal, a rare earth metal alloy, vanadium, magnesium, a magnesium alloy, palladium, calcium, a calcium alloy, and a hydrogen storing alloy. Other than those, oxygen and nitrogen in air may be used by being included in or allowed to flow through the reaction portion 12 as a material for generating heat by reacting with the inflammable substance.

Examples of the odorant used in this case include lauric acid, fatty acids, lactic acid, malic acids, salicylic acid, benzonic acid, phthalic acid, aromatic carboxylic acids, tartaric acid, ethyl acetate, esters, cetyl alcohol, alcohols, naphthalene, skatole, indole, capric acid, p-dichlorobenzene, cresol, N,N-dimethylform-amide, and acetamide.

Desirable examples of a material, which can be used for the reaction portion 12 and generates water by reacting with the inflammable substance, include copper oxide, silver oxide, platinum oxide, metallic oxide, silicon oxide, and other oxides. Other than those, oxygen in air may be used by being included in or allowed to flow through the reaction portion 12 as a material for generating water by reacting with the inflammable substance. The water functions as an intermediate product for releasing the odorant.

Desirable examples of a material, which reacts with the water generated when the inflammable substance is chemically reacted, thereby releasing the odorant, include acetamide, formamide, dimethylformamide, acetamide, acetanilide, benzamide, acid amides, thioesters, ethyl acetate, methyl butyrate, ethyl formate, esters, calcium carbide, aluminum carbide, iron chloride, iron bromide, iron iodide, halogenated metals, iron sulfides, a sulfur compound, acetals, and ketals.

Examples of the odorant used in this case include ammonia, methylamine, dimethylamine, aniline, amines, formic acid, acetic acid, propionic acid, benzoic acid, carboxylic acids, methyl mercaptan, ethyl mercaptan, thiophenol, thiols, methanol, ethanol, propanol, phenol, alcohols, acetylene, methane, hydrogen bromide, hydrogen iodide, hydrogen chloride, hydrogen sulfide, formaldehyde, acetaldehyde, benzaldehyde, aldehydes, acetone, methyl ethyl ketone, diethyl ketone, and ketones.

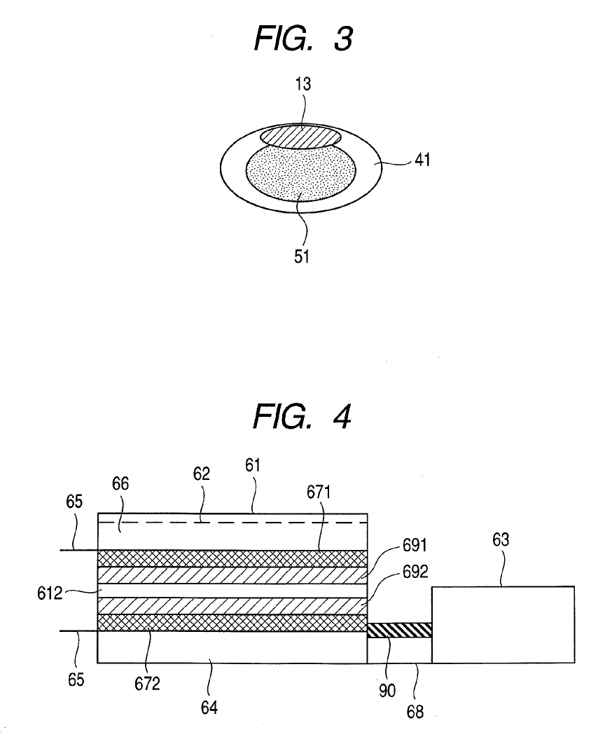

Further, for another structure, an odorant 51 may be contained in a microcapsule 41 as illustrated in FIG. 3. In this structure, the microcapsule 41 is broken by the chemical reaction of the inflammable substance, and the odorant 51 contained therein is released to the outside. Examples of the breakage include mechanical crack, and dissolution and fusion due to a physical or chemical action.

The odorant 51 is desirably a substance having smell which can be recognized even in a small amount. Examples of the odorant 51 include t-butyl mercaptan, dimethylsulphide, and tetrahydrothiophene.

The microcapsule 41 may be made of a material directly chemically reacting with the inflammable substance to be broken by the chemical reaction. Examples of a material of the microcapsule 41 in this case include a phenol resin, a phenol formaldehyde resin, polypropylene, a melamine resin, polystyrene, and cellulose.

Alternatively, the microcapsule 41 may have a structure in which a reaction portion 13 provided adjacently to the microcapsule 41 chemically reacts with the inflammable substance, and the microcapsule 41 is broken due to the action with the heat or the product generated at the time of reaction. Examples of the microcapsule 41 in this case include a melamine resin, gelatin, a urethane resin, polyamide, a urea resin, and a polyurea resin.

There is a method effective for breaking the microcapsule 41, in which a catalyst for promoting chemical reaction is applied to a part of a surface of the microcapsule 41 to provide a catalyst portion constituting the reaction portion 13, and catalytic combustion in the catalyst portion is utilized. In this method, the microcapsule is prepared by a material which is broken by the product such as heat or water by the catalytic combustion. As a result, when the inflammable substance causes the catalytic combustion in the catalyst portion, the microcapsule 41 can be broken by the action of the product such as heat or water generated thereby. The odorant 51 contained therein can be discharged to the outside. Kinds of the catalyst applied to the catalyst portion include platinum and palladium. However, the present invention is not limited to those.

The inflammable substance sensor according to the present invention can be provided to a fuel cell.

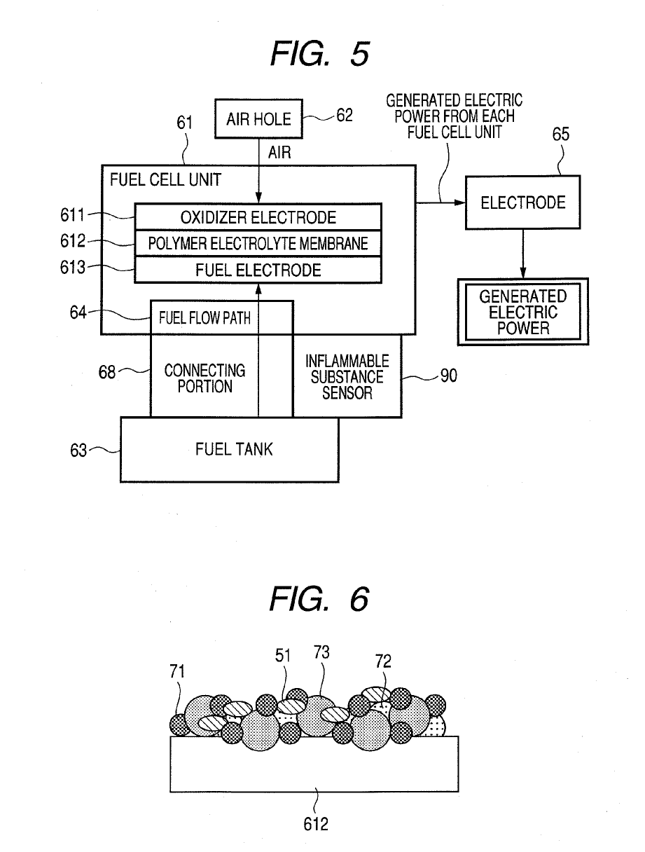

In this case, a structure of the fuel cell will be described. In this case, a polymer electrolyte fuel cell is used as an example. However, the present invention is not limited to this. The present invention may be desirably applied to a fuel cell of other types. FIG. 4 is a schematic structural diagram of the fuel cell. FIG. 5 is a structural diagram illustrating an example of a fuel cell system. In FIGS. 4 and 5, a fuel cell unit is denoted by reference numeral 61 and an electrode is denoted by reference numeral 65.

The inflammable substance serving as a fuel is stored in a fuel tank 63 and is supplied to a fuel electrode 613 through a fuel flow path 64. The fuel electrode 613 includes a diffusion layer 672 and a catalyst layer 692.

For the fuel, an inflammable gas such as hydrogen and hydrocarbon, or an inflammable liquid such as methanol, ethanol, and ether is used. Among those, hydrogen, methanol, and ethanol having high electrical efficiency are desirable, and hydrogen capable of increasing an output of the fuel cell to a maximum degree is more desirable.

An oxidizer is supplied to an oxidizer electrode 611. The oxidizer electrode 611 includes a diffusion layer 671 and a catalyst layer 691.

As the oxidizer, air, oxygen, or the like is used. In particular, when air is used as the oxidizer, the air is desirably supplied from an air hole 62. Further, other than the method of supplying the air as the oxidizer, there may be employed a method of supplying the oxidizer from a tank containing the oxidizer.

In the following, a description will be made of a case where hydrogen is used as the fuel and air is used as the oxidizer. However, according to contents of the present invention, the hydrogen and the air are not obligatory.

The oxidizer and the fuel pass through the diffusion layers 671 and 672, respectively. The fuel performs reaction using a catalyst arranged in the fuel electrode 613. The oxidizer performs reaction using a catalyst arranged in the oxidizer electrode 611. The hydrogen is decomposed into hydrogen ions and electrons by the reaction in the fuel electrode. The hydrogen ions pass through a polymer electrolyte membrane 612 serving as an ion conductor to reach the oxidizer electrode. The electrons are introduced to an electrode to be taken out to the outside as electricity, and then reach the oxidizer electrode. In the oxidizer electrode, on the catalyst, the hydrogen ions and the electrons are bonded with oxygen to generate water.

In those reactions, normally, the fuel and the oxidizer do not mix with each other and each perform the reaction on the catalyst of the each electrode.

The fuel cell at the time of normal operation comes to be a temperature of about 40 to 80° C. under a room temperature environment. On the other hand, a temperature of the fuel cell in a case where the fuel and the oxidizer mix with each other to cause undesirable catalytic combustion, depending on a mixture ratio of the fuel and the oxidizer, exceeds 100° C. in most cases. Therefore, in a case where there is employed a structure in which the microcapsule 41 contains the odorant 51 as shown in FIG. 3, it is desirable that the microcapsule 41 be made of a material containing the odorant 51 which does not cause changes such as fusion at 40 to 80° C. and fuses at high temperature equal to or more than 100° C. to discharge the odorant 51.

An installation position of an inflammable substance sensor 90 of the present invention may be any position other than an inside of the fuel electrode 613, an inside of the fuel flow path 64, an inside of a connecting portion 68, and an inside of the fuel tank 63. However, in order to quickly recognize fuel leakage as soon as the fuel leakage occurs, it is desirable that the inflammable substance sensor 90 be installed in a position where the fuel leakage is likely to occur. For example, the installation may be a peripheral portion of the polymer electrolyte membrane 612 on the oxidizer electrode 611 side, the outside of the connecting portion 68 between a power generation portion and a fuel tank, or the like. FIG. 4 illustrates an example in which the inflammable substance sensor 90 is arranged on the outside of the connecting portion 68.

In a case where the inflammable substance sensor 90 is installed in the peripheral portion of the polymer electrolyte membrane 612, the inflammable substance sensor 90 is desirably installed in an oxidizer flow path 66 or the oxidizer electrode 611. In a case where the oxidizer electrode 611 includes the catalyst layer and the diffusion layer 671, the inflammable substance sensor 90 may be installed in one of the catalyst layer and the diffusion layer 671 or in both of those. In a case where the inflammable substance sensor 90 is installed in the catalyst layer of the oxidizer electrode 611, the catalyst layer of the fuel cell may also serve as the catalyst portion of the inflammable substance sensor of the present invention. Alternatively, the catalyst portion may be provided separately from the catalyst layer.

The odorant released in the above-mentioned manner diffuses to the outside of the fuel cell through the oxidizer flow path. Therefore, even when the fuel cell or a device on which the fuel cell is mounted is not in operation, the odorant can function to quickly and reliably inform a user or the like of occurrence of leakage abnormality.

According to the above embodiment of the present invention, the inflammable substance can be detected with a simple structure and existence of the inflammable substance can be quickly and reliably recognized by a periphery thereof.

Note that, according to the above-mentioned description, the structural example in which the odorant is released from the periphery of the reaction portion is described. However, the present invention is not limited to this.

That is, the reaction portion 11 and the odorant 51 may be provided in positions away from each other. For example, there may be employed a structure in which heat or a product generated in the reaction portion provided in the oxidizer flow path 66 is detected to release the odorant 51 provided on the outside of the fuel cell 61. With this structure, flexible provision allowing adaptation for a shape of a device on which the fuel cell is mounted is enabled.

Hereinafter, examples of the present invention will be described.

### EXAMPLE 1

In Example 1, a description will be made of a fuel cell apparatus in which an inflammable substance sensor according to the present invention is installed in an oxidizer flow path.

First, as the inflammable substance sensor, a microcapsule made of a melamine resin containing t-butyl mercaptan serving as an odorant was prepared by the following method. A diameter of the microcapsule was about 5 μm. A minute amount of platinum black (particle diameter of 10 to 30 nm) was applied to a surface of the microcapsule.

To 300 parts by weight of a 5 wt % solution of pH 4.5, which was prepared by dissolving a styrene-maleic anhydride copolymer (manufactured by Monsanto Company) into a small amount of sodium hydrate, 200 parts by weight of t-butyl mercaptan (manufactured by Kishida Chemical Co., Ltd.) was added, and the resultant was stirred by using an ultra homogenizer, to thereby be emulsified.

On the other hand, 20 parts by weight of melamine and 45 parts by weight of 37 wt % formalin were added to 35 parts by weight of water, and pH of the resultant was adjusted to pH 9.5 by 20 wt % sodium hydrate solution, and the resultant was heated at 85° C. for 15 minutes, thereby preparing a solution of a melamine-formaldehyde initial condensation product.

Next, the solution of the melamine-formaldehyde initial condensation product was added to the above-mentioned emulsified product and was stirred at 75° C. for two hours, thereby obtaining a dispersion of a microcapsule having a melamine resin wall membrane, containing the t-butyl mercaptan.

The dispersion of the microcapsule having the melamine resin wall membrane, containing the t-butyl mercaptan, which was obtained as described above, was sprayed and was dried by a spray drier under conditions of an inlet temperature of 120° C., a nozzle pressure of 1 kg/cm², and a sample transmission amount of 5 g/min, thereby obtaining microcapsule particles containing the t-butyl mercaptan.

The prepared microcapsule had a diameter of about 5 μm. A minute amount of platinum black (particle diameter of 10 to 30 nm) was applied to a surface of the microcapsule.

Next, foamed nickel was cut out by an appropriate size. The microcapsule containing the odorant and an appropriate amount of adhesive were mixed to be applied to a surface of a hole inner wall of the foamed nickel. There was manufactured a fuel cell having a structure in which foamed nickel was used for an air hole serving as an atmosphere intake port.

The fuel cell manufactured in the above-mentioned manner had a structure in which, when hydrogen serving as a fuel leaks out to the oxidizer flow path after an electrolyte membrane is broken, on a surface of the microcapsule applied to the air hole, catalytic combustion occurs. A temperature of the surface of the microcapsule becomes 100° C. or more, so the microcapsule is broken by heat, thereby allowing the t-butyl mercaptan contained therein to be released. Owing to odor thereof, hydrogen leakage is informed to a user or a person therearound, that is, the outside so that they can recognize the hydrogen leakage.

### EXAMPLE 2

Next, a description will be made of a case where an inflammable substance sensor according to the present invention is provided to a catalyst layer of an oxidizer electrode of a fuel cell.

As illustrated in FIG. 6, the catalyst layer of the fuel cell has a structure in which a catalyst 71 is arranged on the polymer electrolyte membrane 612. In order to obtain diffusibility of the fuel or the oxidizer, the catalyst layer is made of a porous body or a fine particle body and is electrically connected to a gas diffusion electrode. Further, in order to effectively form an ion path, an electrolyte 72 is mixed into the catalyst layer in some cases. Further, in order to increase utilization efficiency of the catalyst 71, the catalyst 71 is made into fine particles to be carried by carrier particles 73 such as carbon in some cases.

In this example, as illustrated in FIG. 6, a microcapsule 51 containing the t-butyl mercaptan according to Example 1 and including a melamine resin and catalyst particles including platinum are mixed with each other, thereby forming the catalyst layer. When a polymer electrolyte membrane 612 is broken and a fuel leaks out therethrough, due to an action of the catalyst 71, catalytic combustion occurs. As a result, a temperature of the catalyst layer increases. Due to heat obtained thereby, the microcapsule 41 is broken, thereby allowing the t-butyl mercaptan to be released. Owing to odor thereof, hydrogen leakage can be recognized by a user or a person therearound. The microcapsule used in this example may be one having a surface applied with catalyst fine particles in advance or one having the surface applied with no catalyst.

### EXAMPLE 3

Subsequently, a description will be made of a case where an inflammable substance sensor of the present invention is provided to a diffusion layer of a fuel cell.

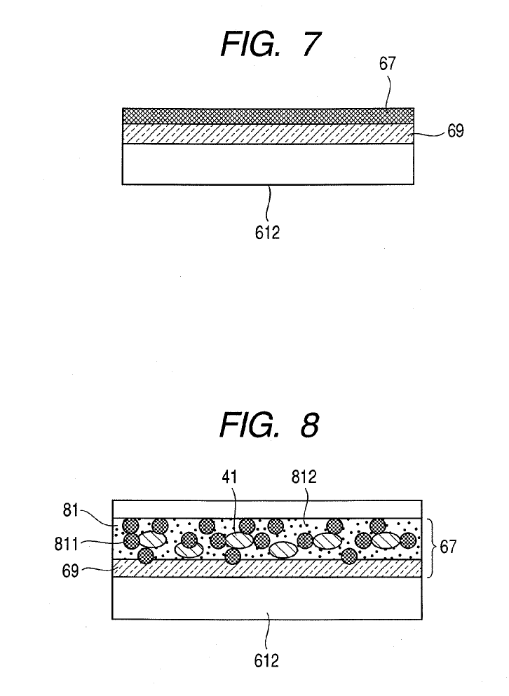

As illustrated in FIG. 7, the fuel cell has a diffusion layer 67 on an outer side of a catalyst layer 69 provided on the polymer electrolyte membrane 612. The diffusion layer 67 has the following structure. In the structure, a diffusion electrode layer comes into contact with the catalyst layer 69 and a carbon porous body is used in many cases. The carbon porous body may have a microporous layer (MPL layer) in which carbon fine particles and a hydrophobic resin such as PTFE are mixed with each other on a catalyst layer-side surface formed of carbon paper or carbon cloth in some cases. Further, there is also a case where the carbon porous body includes a diffusion collecting layer having diffusibility or a diffusion insulating layer having diffusibility for electrical insulation on an outer side thereof. The diffusion collecting layer is made of a material obtained by processing metal or carbon, such as foamed metal. Used for the diffusion insulating layer is a plastic material.

In this example, as illustrated in FIG. 8, in forming the MPL layer, carbon fine particles 811, a PTFE resin 812, the microcapsule 41 the same as the microcapsule according to Example 1 were mixed with each other at the same time, and the resultant was applied to carbon paper. The polymer electrolyte membrane is denoted by reference numeral 612 and the diffusion layer is denoted by reference numeral 67. The carbon porous body having a microcapsule-containing MPL layer 81 was used for the diffusion electrode layer of the fuel cell in a state where the MPL layer and the catalyst layer come into contact with each other. Also in this example, when the electrolyte membrane is broken and the fuel leaks out, the catalytic combustion occurs in the catalyst portion of the fuel cell. As a result, a temperature of the catalyst layer 69 increases. Due to heat obtained thereby, the microcapsule 41 is broken, thereby allowing the t-butyl mercaptan to be released. Further, in a case where catalyst fine particles are applied to the surface of the microcapsule in advance, the catalytic combustion occurs on the surface of the microcapsule. Accordingly, the microcapsule 41 can be broken with more reliability.

### EXAMPLE 4

In this example, as illustrated in FIG. 4, a description will be made of a case where an inflammable substance sensor of the present invention is provided to a connecting portion between a fuel flow path of the fuel cell and a fuel tank.

The connecting portion between the fuel flow path 64 of the fuel cell and the fuel tank 63 may be provided with, in addition to a connecting valve, a pressure control valve for stabilizing a pressure of a fuel supplied to a fuel electrode. In this example, the microcapsule according to Example 1 was mixed into a coating agent such as rust-inhibitor and a coating material applied to outer walls of the connecting valve and the pressure control valve, and the coating was applied thereto. As a result, when hydrogen leakage occurs in the connecting portion, catalytic combustion occurs on the surface of the microcapsule. Due to heat generated thereby, the microcapsule is broken, so the odorant is released to the outside.

### EXAMPLE 5

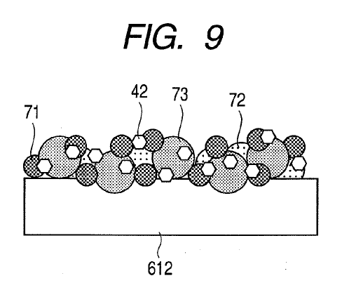

In this example, as illustrated in FIG. 9, there is adopted, as an odorant releasing member, a catalyst layer formed by mixing acetamide in a powder form and catalyst fine particles. An electrolyte is denoted by reference numeral 72 and a carrier is denoted by reference numeral 73.

When the polymer electrolyte membrane 612 is broken to allow a fuel to leak out therethrough, in the catalyst 71 of the fuel cell, catalytic combustion occurs. As a result, a temperature of the catalyst layer increases, and water is generated at the same time. Due to the heat and water, an acetamide 42 undergoes hydrolysis, thereby allowing ammonia and acetic acid to be released. Owing to odor thereof, a user or a person therearound can recognize hydrogen leakage.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2006-290086, filed Oct. 5, 2006, which is hereby incorporated by reference herein in its entirety.

1. An inflammable substance sensor for informing of a detection of an inflammable substance, comprising an odorant releasing member for releasing an odorant due to a chemical reaction of the inflammable substance.

2. The inflammable substance sensor according to claim 1, wherein the odorant comprises a product produced by the chemical reaction of the inflammable substance.

3. The inflammable substance sensor according to claim 1, wherein the odorant comprises a substance to be vaporized by heat generated by the chemical reaction of the inflammable substance.

4. The inflammable substance sensor according to claim 1, wherein the odorant comprises a product produced by a chemical reaction of an intermediate product produced by the chemical reaction of the inflammable substance.

5. The inflammable substance sensor according to claim 1, wherein the odorant is contained in a microcapsule.

6. The inflammable substance sensor according to claim 5, wherein the microcapsule is made of a material which directly chemically reacts with the inflammable substance.

7. The inflammable substance sensor according to claim 5, wherein the microcapsule is broken by at least one of heat and an intermediate product generated by the chemical reaction of the inflammable substance.

8. The inflammable substance sensor according to claim 1, further comprising a catalyst portion for promoting the chemical reaction of the inflammable substance.

9. The inflammable substance sensor according to claim 5, further comprising a catalyst portion for promoting the chemical reaction of the inflammable substance provided onto a surface of the microcapsule.

10. The inflammable substance sensor according to claim 8, wherein the catalyst portion comprises platinum.

11. The inflammable substance sensor according to claim 4, wherein the intermediate product comprises water.

12. The inflammable substance sensor according to claim 1, wherein the inflammable substance comprises at least one substance selected from the group consisting of hydrogen, methanol and ethanol.

13. A fuel cell comprising:
a fuel electrode to which a fuel is supplied;
an oxidizer electrode to which an oxidizer is supplied;
an ion conductor provided between the fuel electrode and the oxidizer electrode;
a fuel flow path;
an oxidizer flow path; and
the inflammable substance sensor according to claim 1.

14. The fuel cell according to claim 13, wherein the oxidizer electrode comprises a catalyst layer and the catalyst layer is provided with the inflammable substance sensor.

15. The fuel cell according to claim 13, wherein the inflammable substance sensor is provided to a connecting portion between a fuel tank and the fuel flow path.

16. The inflammable substance sensor according to claim 9, wherein the catalyst portion comprises platinum.

17. The inflammable substance sensor according to claim 7, wherein the intermediate product comprises water.
